(19) United States
(12) Patent Application Publication
(10) Pub. No.: US 2004/0190553 A1
(43) Pub. Date: Sep. 30, 2004

(54) Flexible channel system

(76) Inventors: Vivian John Ward, Burnaby (CA); Leonard George Pucker II, Surrey (CA)

Correspondence Address: Peter van Baarsen, c/o Spectrum Signal Processing Inc., 200-2700 Production Way, Burnaby, BC, V5A 4X1, CA

(21) Appl. No.: 10/396,796

(22) Filed: Mar. 26, 2003

(51) Int. Cl. H04J 3/24

(52) U.S. Cl. 370/474; 370/535

(57) ABSTRACT

This is disclosed a flexible, scalable channelized processing system composed of a relatively small number of component types. It extends switching fabric concepts into the processor FPGAs to create advantageously thereby a “processing fabric” that allows the same buses to be shared by multiple data channels, that assists on coordinating the timing of events, and that assists on management functions (related to administration, monitoring and supervision) of the processing.

### FIELD OF THE INVENTION

This invention relates to channelized processing systems.

### BACKGROUND OF THE INVENTION

Channelized systems are those in which multiple, channelled data streams are subjected to a sequence of (often similar or related) processing steps. Channelized processors provide these processing steps while maintaining as many distinct (physical) paths as are required (typically one for each channel). As the number of channels/paths increases, the complexity of the structures necessary to maintain them also increases (typically non-linearly disadvantageously). In particular, when implemented in a Field Programmable Gate Array (FPGA) or similar implementation technology, ever-greater logic and routing resources must be used simply to provide data and control buses for each channel/path as their numbers increase.

Conventional fixed-function processors have some or all of the following characteristics: data paths are usually distinct for each channel, and control bus overhead increases with each channel added; poor and non-linear scaling; expensive memory-mapped FIFO memories for each channel; awkward synchronization between channels; and no System-on-a-Chip (SOC) migration path.

### SUMMARY OF THE INVENTION

According to one aspect of this invention, there is provided a method of processing a first external stream according to a user application, comprising the steps of: (a) rendering the user application into a plurality of algorithms and logically connecting them with paths, all according to a first logic and with common logical communications paths; (b) instantiating said plurality of algorithms and common logical communications paths; (c) packetizing the first external stream, where the packets are logically connected among themselves according to a second logic; (d) dividing said packetized data stream into a plurality of packetized sub-streams according to said first logic, and embedding a Control Step in one said packetized sub-stream; (e) channelling and processing said plurality of packetized sub-streams, according to said instantiated plurality of logically connected algorithms and common logical communications paths; wherein two of said packetized sub-streams, asynchronously share one said instantiated common communications path.

According to another aspect of this invention, there is provided a method of processing a first external stream according to a user application, comprising the steps of: (a) rendering the user application into a plurality of algorithms and logically connecting them according to a first logic and with common logical communications paths; (b) instantiating said plurality of algorithms and common logical communications paths; (c) packetizing said external stream, where the packets are logically connected among themselves according to a second logic; (d) dividing said packetized data stream into a plurality of sub-streams of packets according to said first logic, wherein said first logic includes (i) inserting packet in one said packetized sub-stream that has local information about a desired portion of that packetized sub-stream, and (ii) using downstream, said local information; (e) channelling and processing said plurality of packetized sub-streams, according to said plurality of algorithms; wherein two of said packetized sub-streams, asynchronously share one said instantiated common communications path.

According to another aspect of this invention, there is provided a method of processing an external stream according to a user application, comprising the steps of: (a) rendering the user application into a plurality of algorithms and logically connecting them according to a first logic and with common logical communications paths; (b) instantiating said plurality of algorithms and common logical communications paths; (c) providing an I/O wrapper for receiving parts of external stream that are irregular and packetizing said external stream, where the packets are logically connected among themselves according to a second logic; (d) dividing said packetized data stream into a plurality of sub-streams of packets according to said first logic, wherein said first logic includes (i) inserting one packet in one said packetized sub-stream that has local information about a desired portion of that packetized sub-stream, and (ii) using downstream, said local information; (e) channelling and processing said plurality of packetized sub-streams, according to said plurality of algorithms; wherein two of said packetized sub-streams, asynchronously share one said instantiated common communications path.

According to another aspect of this invention, there is provided a kit for programming an user application on a synthesizable hardware platform, comprising: (a) a library of run-time synthesis tools employable on the hardware platform, for processing packets according to a desired algorithm; (b) an I/O wrapper that is preprogrammed on a first hardware platform for accepting two input data streams arriving asynchronously in the format of said user application, and for packetizing them for a synthesized algorithm.

### BRIEF DESCRIPTION OF THE DRAWINGS

A better understanding of the present invention can be obtained when the following detailed description of the preferred embodiment is considered in conjunction with the following drawings, in which:

FIG. 1 shows a conceptual block diagram of the major components of this invention;

FIG. 2 shows a more complex exemplary version of FIG. 1;

FIG. 3 shows a more detailed and complex exemplary version of FIG. 2;

FIG. 4 shows the waveform diagram of a packet;

FIG. 5 lists the Types of packets;

FIG. 6 shows the header format for packets;

FIG. 7 shows the header and payload for a Configuration Write packet;

FIG. 8 shows the header and payload for a Configuration Read packet;

FIG. 9 shows the header and payload for a Configuration Read Response packet;

FIG. 10 shows the header and payload for a Relative Position packet;

FIG. 11 shows the format of an exemplary Relative Position packet;

FIG. 12 shows changes of packet data widths;

FIG. 13 shows a bus driver;

FIG. 14 shows a Basic Algorithm Wrapper;

FIG. 15 shows the parameters of an Algorithm Wrapper;

FIG. 16 shows a Multiple Context Algorithm Wrapper;

FIG. 17 shows an external FIFO memory manager;

FIG. 18 shows the parameters associated with a FIFO memory channel;

FIG. 19 shows the parameters of the FIFO memory manager; and

FIG. 20 shows the block diagram of a Data Stream Synchronizer.

### DETAILED DESCRIPTION OF THE PREFERRED EMBODIMENT INTRODUCTION

This invention provides and supports a flexible, scalable channelized processing system composed of a relatively small number of component types. It extends switching fabric concepts into the processor FPGAs to create advantageously thereby a “processing fabric” that allows the same buses to be shared by multiple data channels, that assists on co-ordinating the timing of events, and that assists on management functions (related to administration, monitoring and supervision) of the processing.

This invention provides a channelized architecture intended for, in its preferred embodiment, FPGAs and like implementation technologies. It is designed to minimize the overhead required to maintain channels, without placing significant restrictions upon the user applications to be implemented. This minimization is achieved by providing a packet-based structure that shares buses by multiple data channels and their associated control information. The use of standardized interfaces and processing patterns results in reduced system complexity.

Although this invention is primarily intended for FPGA implementation, and in one aspect thereof, can be viewed as a method of implementing algorithms on an FPGA, there are other aspects of this invention that are employable advantageously in non-FGPA situations, and are in fact implementation-agnostic. In particular, this invention recognizes that “real time” processing need not be tied “rigorously” to an external timing reference and that satisfactory results can be obtained by recognizing that the desired cooperation between data streams or the desired routing of a data stream, can be triggered by information embedded within the data stream(s) itself. These examples are part of a more generalized recognition that some aspects of processing are better being “locally informed and locally controlled”.

One benefit of this invention's approach is that packets are processed as they arrive at an algorithm—no direct relationship to the real-time data rate is enforced. This provides a great benefit during development and testing for (both algorithm and system) designers. A real-time data source may be replaced with buffered or generated data, and the output results will be identical. For instance, where input comes from an A/D converter, the input data could be replaced with samples from an Ethernet-connected computer. In this case, the invention would process the incoming data at the rate it is presented, in exactly the same way as it would process A/D data. This allows simulated input data to be fed and processed, with intermediate and final results being captured and examined.

The preferred embodiment described below is for user applications in SDR (Software Defined Radio), using the TDMA (Time Division Multiple Access) protocol, with occasional reference to other SDR protocols (e.g. CDMA (Code Division Multiple Access)) for purposes of illustrating variants.

In contrast to conventional, fixed-function processors, this invention has the following characteristics integrated data and control paths are shared by channels; simple structure scales well to 1000-channel systems; expensive external FIFO memories are shared by channels; synchronization of signals arriving asynchronously without reference to an external clock; allows hardware processing units to be shared by multiple channels; and provides a migration path to SOC.

### Basic Concept

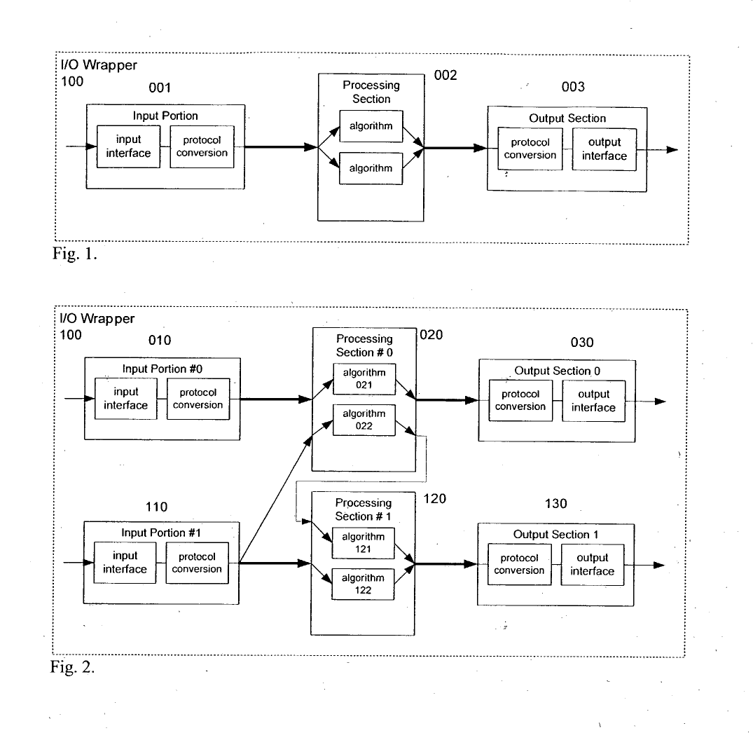

In basic concept, this invention processes an external data stream according to a user application, as shown in FIGS. 1-3, and resides in and within I/O Wrapper 100. In the preferred embodiment, I/O Wrapper 100, and the Processing Sections, Output Sections and Input Portions “cradled” thereby, are synthesized on an FPGA.

Herein, the term “external” (and derivatives thereof), means “external to I/O Wrapper 100”, so that, for example, an “external stream” or an “external intelligence”, resides or originates outside I/O Wrapper 100 and must enter therethrough. The term “local” (and derivatives thereof) means in or within I/O Wrapper 100, so that “local information”, for example, resides or is generated within Wrapper 100 (i.e. an Input Portion, Processing Section or Output Section). Herein, the user application manifests itself (through designer efforts) in “intelligence” that is implemented by software/hardware/firmware, either externally (hence, “external intelligence”) or locally (i.e. by and within I/O Wrapper 100 and in particular, the Output Sections and Input Portions, and in and within Processing Sections and Algorithms therewithin, explained below). Derivatives thereof, like “intelligently”, are used herein to describe activities and process performed according to this invention's channelized processing and to such external aspects of the user application cooperating with this invention's channelized processing, explained below. Herein, the term “data” used as an adjective (as in “data channel”, “data sub-stream” or “data stream”) does not preclude the occasional presence of control information (e.g. Configuration-type packets, explained below) because the common communications paths within I/O Wrapper 100 herein, do not distinguish between different types of “payload” (e.g. control information versus non-control data).

With reference to FIG. 1, an external stream is transformed by Input Portion 001 into sub-streams and channelled to Processing Section 002 for processing thereby and eventual departure through Output Section 003. Input Portion 001 contains an input interface for signals from an external part, plus any protocol conversion necessary to move data thereafter in accordance with the invention's packet protocol. Processing Section 002 contains one or several processing Algorithms, with the infrastructure necessary to support them. Each Algorithm accepts a packetized sub-stream from Input Portion 001, and outputs a processed, packetized sub-stream. Output Section 003 contains an output interface to an external part, plus any protocol conversion needed to accept and move the (packetized and processed) sub-streams, onto an external part. External parts could be CPUs, A/D Converters, D/A Converters, DSPs, and the like—this invention imposes no restrictions on the external parts because it focuses on the data streams therefrom and thereto.

The combination of Input Portion 001 and Output Section 003 forms I/O Wrapper 100 that encapsulates, hosts and supports Processing Section 002, and relieves it (wholly or substantially) from being concerned with several aspects of the signals from and to the external parts, and of their efficient processing. I/O Wrapper 100 isolates Processing Section 002 (and correspondingly, its designer) from the irregular (“noisy”) aspects of the external stream (e.g. the irregular timing of the arrival of signals of the external stream, or the non-uniform formats thereof). I/O Wrapper 100 sets the stage for the packetized processing conducted by (and within) Processing Section 002 that facilitates the creation of logical channels therein (without undue increase in supporting infrastructure, and the synchronization of several data streams without reference to an external or common clock). Such facilitated logical channels and synchronization can be effected and manipulated (e.g. reconfiguring dynamically if desired) much easier than can be achieved by a processor with resources dedicated per channel. Efficiencies are created thereby, whether for design, testing or execution performance.

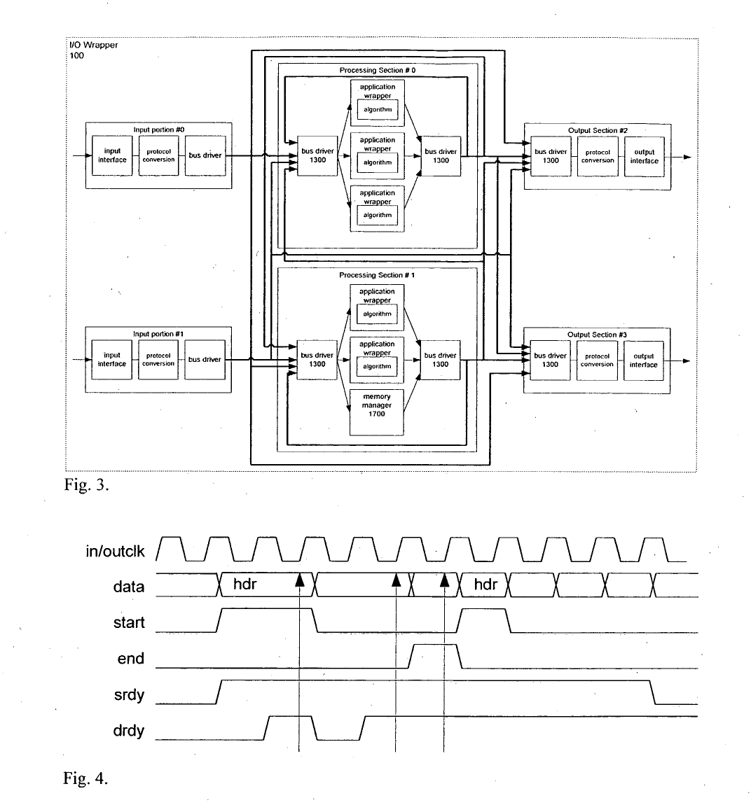

FIGS. 1-3, in increasing complexity, show various (parallel and sequential routed) processing of sub-streams among Algorithms within a single Processing Section and among Algorithms of several Processing Sections, all in a “pipeline” fashion. Although much of the packetized data flows (i.e. sub-streams) are intended to progress linearly from Input Portion to Processing Section to Output Section (as shown in FIG. 1), other routes are possible. In fact, in some user applications, more complex routing (i.e. interactions) among Input Portions and Output Sections is desirable to create efficiencies or take advantage of efficiencies elsewhere within I/O Wrapper 100 (as will be explained below in conjunction with Control Steps and Algorithm Wrappers). FIGS. 2-3 show increasingly more detailed and complex exemplary versions of the general concept of FIG. 1. For example, as seen in FIG. 2, a packet leaving Algorithm 022 in Processing Section #0 might be routed to the input of Algorithm 121 of Processing Section #1, with the resulting packet being sent to Output Section #3. A yet more complex example is shown in FIG. 3.

With reference to FIGS. 1-3, the user application that desires to process one or (typically) more external streams, is conceptually rendered (by a designer), according to a first logic, into a sequence of Algorithms for processing (a packetized version of) those external streams. More particularly, an external stream is rendered into a first logical arrangement of sub-streams flowing from the Input Portion(s) to Output Section(s), through and in accordance with an intermediate sequence of Algorithms. A packetized sub-stream herein is created within and by the Input Portion from the external stream it accepts for processing within I/O Wrapper 100. The packets are organized among themselves (i.e. within the sub-stream) according to a second logic that (at least in the preferred embodiment) governs all packets within all sub-streams (i.e. within I/O Wrapper 100, a single packet protocol governs). This invention imposes no limits on the complexity of the first logic (of the routed processing among Algorithms), or on the complexity of the second logic (of the relationship among the packets themselves in the sub-streams).

Herein, the term “rendering” (and derivatives) might be interpreted appropriately in the relevant art, as “algorithm mapping” which is the process of mapping an algorithm to a parallel architecture (or sequential, hybrid or packetized architectures, as other examples) that requires the partitioning of tasks or data sets into smaller units and allocating each to a processor, and where that partitioning is done on a functional, temporal or spatial basis, or some other basis relevant to the user application. Herein, the term “rendered” is used for its economy of expression and to refer to the entire process of “algorithm mapping” the user application into smaller portions (herein, Algorithms, for example) and “gluing” them together (herein, packet and addressing protocol, for example) and finally to its implementation (FPGA, in the preferred embodiment).

An “Algorithm” herein, is understood conceptually to be a defined process or set of rules that leads to the development of a desired output from a given input; a sequence of formulas and/or algebraic/logical steps to calculate or determine a given task. An Algorithm herein, is parameterizable. Those parameters can be changed dynamically according to the preferred embodiment using an FPGA implementation. Herein, the term “dynamically” (or derivatives) means colloquially, “on the fly” or “in real time” (and with current FPGAs, within one microsecond or shorter); and more precisely, describes activities that develop or occur dynamically, typically during run time, rather than as the result of something that is statically predefined.

A “gate array” is a general type of integrated circuit that contains unconnected logic elements (such as two-input NAND gates). These gate arrays may be programmed to produce a specific application of a digital design to allow a general logic building block to be tailored for a specific application. An FPGA allows specific application instructions to be programmed “directly into the gate array” or “synthesized”. A single copy of a running program in an FPGA is considered as an “instantiation” of the program in the FPGA.

The designer renders the user application into the aforementioned Input Portions, Output Sections and Algorithms according to a first logic and organizes the packets themselves according to a second logic, and then synthesizes or instantiates on the FPGA. The synthesis is achieved by conventional synthesis tools (e.g. Verilog or VHDL (Very Large-scale Integrated Circuit Hardware Description Language). Within I/O Wrapper 100, the designer works with conventional synthesis tools without concern about irregular timing of arrival of data and the format of data. In other words, the programming and design “grammar” is simplified because the format of data is regularized into a single packet protocol, and the sensitivities which normally attend the timing of external signals, are substantially reduced. The designer is left to concentrate on designing the best Algorithms and the best first and second logics that “glue” the Algorithms together.

Once synthesized, current FPGAs have the capability of being reconfigured dynamically in limited portions thereof (it is not yet possible to reconfigure large portions thereof). This invention takes advantage of these reconfigurability capabilities with Configuration-type packets (explained below) for “local information and control” explained below.

The aforementioned rendering of routing of a sub-stream (from Input Portion to Output Section(s)), through a particular sequence of Algorithms, defines a (logical) channel herein. Herein, the term “channel” refers to a communications path within I/O Wrapper 100, originating in an Input Portion and ending in an Output Section(s) and does not refer to any particular physical medium but rather to the set of properties that distinguishes one channel from another. Herein, the set of properties that distinguishes one logical channel from another includes the (Section # and Source Id) packet addressing scheme, explained below.

For a TDMA user application, the second logic might be motivated by sequential sampling of an external analog RF signal, so that, for example, the (data payload of the) packets are (or are derived from) samples created in chronological order; and the first logic might (as a very simple example for illustration purposes only) be manifested by the Algorithms and logical channels shown in FIG. 2, where Algorithm 021 is a peak detector, Algorithm 022 is a filter, Algorithm 121 is a decimator, Algorithm 122 is a filter, and the inputs to Input Portions 010 and 110 are the results of an ADC.

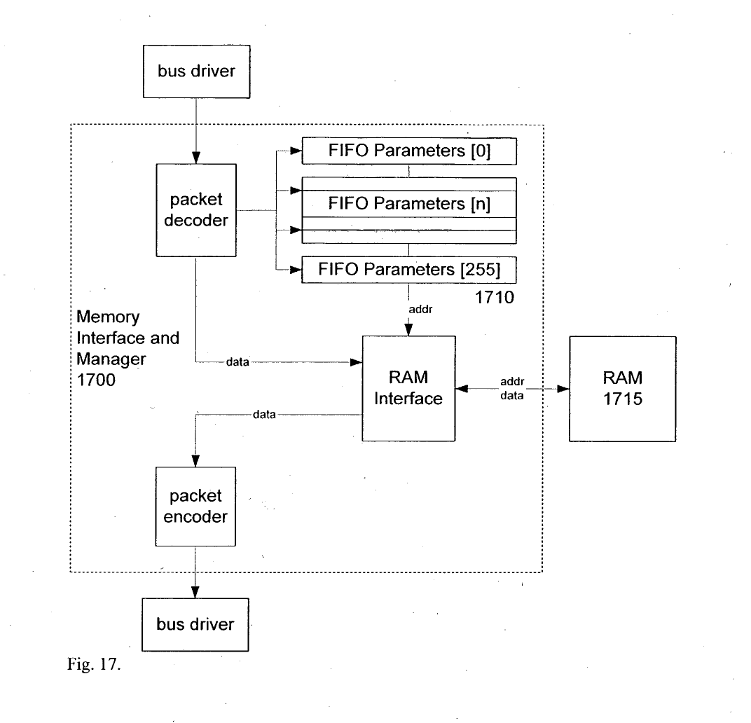

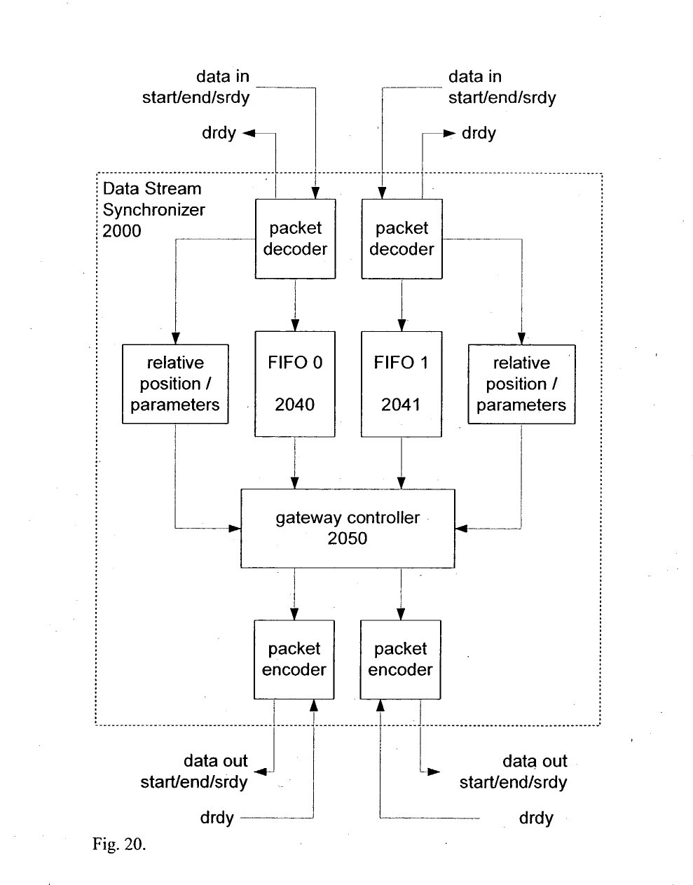

Although most Algorithms provide “data processing” or “number crunching” according to the user application, some Algorithms are usefully employed to support such processing (such as an external FIFO memory manager and a Data Stream Synchronizer, explained below respectively in conjunction with FIGS. 17-19 and with FIG. 20, and Quality of Service QOS) functions, explained below).

In FIG. 3, functions like classification (determining the destination in the downstream environment and any special processing requirements), modification (changing the contents of the payload, for example, doing encryption or security processing), queuing (assigning a queue (specifying priority) for presentation to the downstream environment), and like and related functions, have been collapsed for simplicity of explanation, into “interface”, “protocol conversion” and “bus driver” in, for example, Input Portions #0 and #1, and Output Sections #2 and #3. One important task of the Input Portion, according to one aspect of this invention, is to intelligently embed “local information” into the sub-stream (explained below in conjunction with the Relative Position packet).

Each Processing Section and Output Section has a unique identifier (“Section #”). Input Portions will apply to (the headers of) Data and Relative Position packets, the Section #s (i.e. the destination Processing Section(s)) and Source Id(s) (i.e. the source(s) from which they came). An Algorithm's input accepts Data and Relative Position packets from a (parameterized) source (i.e. the “correct” Source Id as part of the logical channel defined) and from no other source; and its output packets are a source of data for other Processing Sections or Output Sections. This format allows data to be sent from a single source to as many Processing Sections or Output Sections as (are parameterized to) choose to accept it. The addressing scheme combination of Section # (where the packet is to go) and Source Id (where the packet came from), applied to each packet as it leaves an Input Portion or Processing Section, establish a logical channel within I/O Wrapper 100 for Data packets and Relative Position packets to flow. Note that in FIG. 1, the sub-stream from Input Portion 001, is “copied” to both Algorithms in Processing Section 002, but that in FIG. 3, what is shown as several paths leaving bus driver 1300 for several destination Algorithms, does not necessarily mean that a Data packet of an outgoing sub-stream from bus driver 1300 is “copied” to those several destination Algorithms. Such a Data packet's routing is governed by not only the destination Section # but also the Source Id in its header, i.e. it flows according to applicable logical channel.

The Input Portion is so termed (i.e. it is not termed “Input Section” to align semantically with “Processing Section” and “Output Section”) only to make a distinction at the level of addressing implementation. The Section # is the first level destination address of all packets created by this invention (i.e. by and within I/O Wrapper 100) and is used to route all packets created thereby within the context of this invention (i.e. to all Processing and Output Sections). Because of the function of the (servant) nature of the input process or component that must accept whatever the (master) external part presents it and because packets do not have an existence outside I/O Wrapper 100, packets cannot have a destination Section # for such input process or component, and therefore, it is conceptually cleaner to avoid calling that input process or component, a “section”. This semantical distinction does not affect the function of the Input Portion as the first (and an integral) part of I/O Wrapper 100 that an external signal confronts.

In summary of the basic concept, the user application manifests itself in intelligence to process the external stream in a sequence of Algorithms, according to a first logic, operating on a packetized version of that external stream (or more particularly, on packetized sub-streams according to that first logic), where the packets are organized among themselves according to a second logic.

### Packet

As seen in FIG. 4, a “start” signal indicates the beginning of a new packet, an “end” signal indicates the last word of each packet, and data is transferred on the rising clock edges if both lines “srdy” (“send ready”) and “drdy” (“data ready”) are asserted (as indicated by the three arrows in FIG. 4). A packet with “hdr” (“header”) followed by two words before another packet “hdr” arrives, is shown in the “data” line of FIG. 4. The width of the data path (i.e. length of packet header and payload) may vary (e.g. 16, 24, or 32-bits) at different places in processing (as explained below in conjunction with FIG. 12, packet buffers and parameterizable Algorithms) but (at least in the preferred embodiment) is not variable in the sense that the component that receives a packet does not know its length before receipt.

Some special packets are created externally upstream (e.g. see below, on Configuration-type packets created by an external intelligence) but packets typically are created by the Input Portion of I/O Wrapper 100 (e.g. by “protocol conversion” in Input Portion 001 in FIG. 1).

As will become evident from the explanation of packets below, this invention's architecture does not differentiate between data sources in Input Portions and data sources in Algorithms. The same structures that allow input data to be routed to the Algorithms that require it, also allow the output of Algorithms to be routed to other Algorithms or to Output Section. Although passing data through multiple Algorithms within the same Processing Section is not a requirement of all channelized systems, it is a valuable side-benefit for some user applications.

Logical Relationship Among Packets

Within I/O Wrapper 100 and among the Algorithms, the present invention teaches a switched-packet protocol. It organizes an external stream into one or a plurality of sub-streams of packets that are notionally linked in a logical relationship (according to the user application or the designer thereof). Although there are no inherent limitations to this logical relationship, the chosen relationship will presumably be motivated by the user application where the data stream finds itself (e.g. a relationship that facilitates computational processing thereof). As a first example, in the TDMA context of the preferred embodiment, a logical relationship among the packets can be created by timestamping them and then processing them (and perhaps reassembling them or otherwise dealing with them as a function of their timestamps), where the timestamps might or might not bear any relationship with absolute time or some system time. Alternatively, as a second example, a logical relationship can be created by serializing the packets with sequence numbers. The first example of logical relationship is suggested by the TDMA context and the chronological creation of time samples or slices of an external analog signal. The second example of logical relationship, will typically (but not necessarily) be dictated by the order of chronological creation of the packets (i.e. packet n was created before packet n+1, etc.).

Furthermore, and unlike the preceding TMDA examples, a logical relationship among the packets can also be created that has no connection to the order of their physical creation or to any external clock. For example, each packet is logically linked to another packet that has no regard to the order of their creation (e.g. packet n has a pointer to packet n+4, packet n+1 has a pointer to packet n+2, packet n+2 has a pointer to packet n+3, packet n+3 has a pointer to packet n+5, etc.). A CDMA user application (or portions thereof, like convolutional error correcting codes) might suggest or motivate a logical relationship among the packets that is useful to it, that is quite unlike what a TDMA context would suggest. In short, the organization of the logical relationship among packets is typically motivated (i.e. guided and sometimes dictated) by the user application, limits of processing power, constraints of overhead, and other relevant factors. This invention places no restrictions on the type or complexity of logic among the packets. Furthermore, even in the TDMA context of the preferred embodiment, the conventional aspects of timestamping or timestamped packets, has been superseded by recognizing according to this invention, that the logic among the packets need not necessarily be connected to an external timing mechanism. This will be explained below in conjunction with Relative Position packets.

Packet Header

Packets begin with a header followed by a payload. In addition to other information typically found in a packet header (e.g. information related to error checking and correction, common administrative functions, encryption and security, and the like, which are omitted herein for simplicity of explanation only), all packet headers contain a Section #, identifying the destination (Processing or Output) Section # that the packet is to be sent to (see FIG. 6). The Section # is the primary, first level address within I/O Wrapper 100. The header contains additional addressing information, depending on the type of packet. The header of a Data packet and a Relative Position packet has a Source Id that identifies the source that generated the packet (typically an Input Portion # or a Processing Section #). A Configuration-type packet header has a physical address, which can be seen as a second level, internal address within the destination Section #. These types of packets will be explained below.

When (the Data packets of) a sub-stream is processed, altered, merged, or separated, a new Source Id and Section # is applied to each packet of the resulting data streams.

Types of Packets

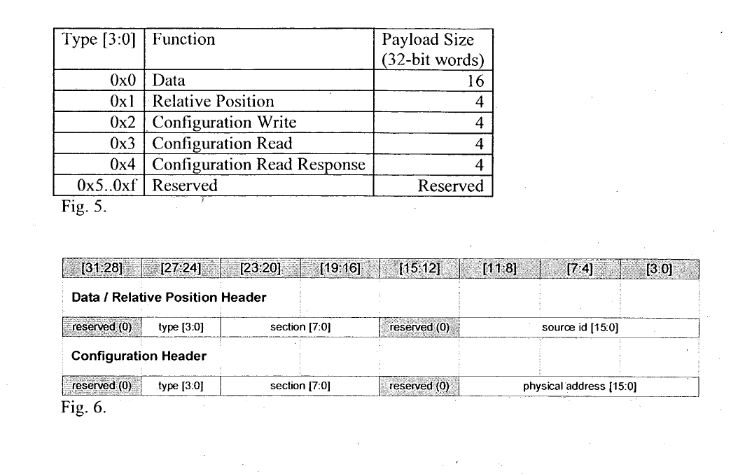

FIG. 5 is a listing of some exemplary packet types and (length of) payloads: Data, Relative Position, and three Configuration-type packets (namely, Configuration Write, Configuration Read, Configuration Read Response). FIG. 6 shows the headers for these packets. These various packets/payloads (except for the first self-explanatory one, Data packet) will be explained in conjunction with FIGS. 6-9, and play a role as Control Steps, explained below.

Configuration Write Packet

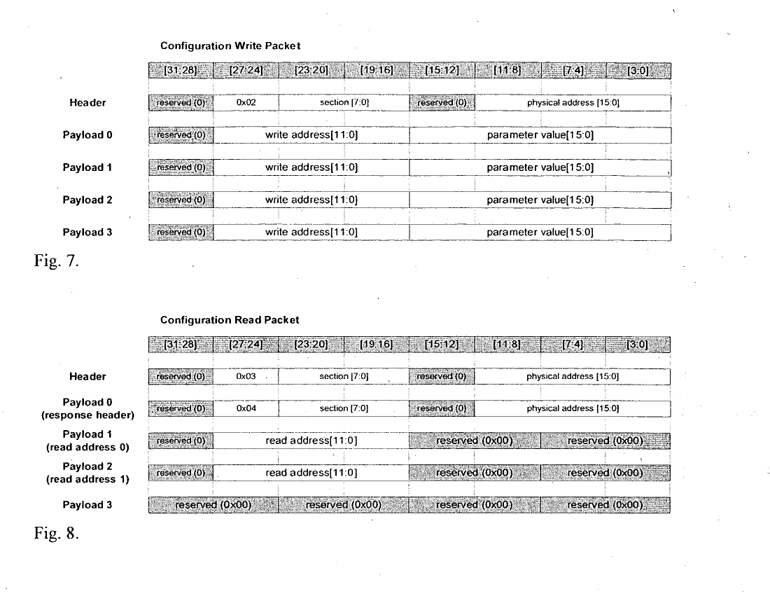

A Configuration Write packet (see FIG. 7) is sent to the desired Algorithm to change the value of one or more of its parameters. This Configuration Write packet contains in its header, the Algorithm's destination Section #, its physical address (i.e. the second level, internal address in the Algorithm's section#), and contains in its payload, each parameter's particular address (a third level address, usually expressed as an offset from a base address of the physical address), and the new value(s) therefor.

Configuration Read Packet

Similarly, a Configuration Read packet (see FIG. 8) is sent to the desired Algorithm to obtain the value of the desired parameter by triggering the return sending of a Configuration Read Response packet (explained next). This Configuration Read packet contains in its header, the Algorithm's Section # and physical address (i.e. the second level, internal address in the specified Algorithm section), and contains in its payload, the parameter's particular (e.g. offset) address, and the (return address) header to be used by the Configuration Read Response packet, next.

Configuration Read Response Packet

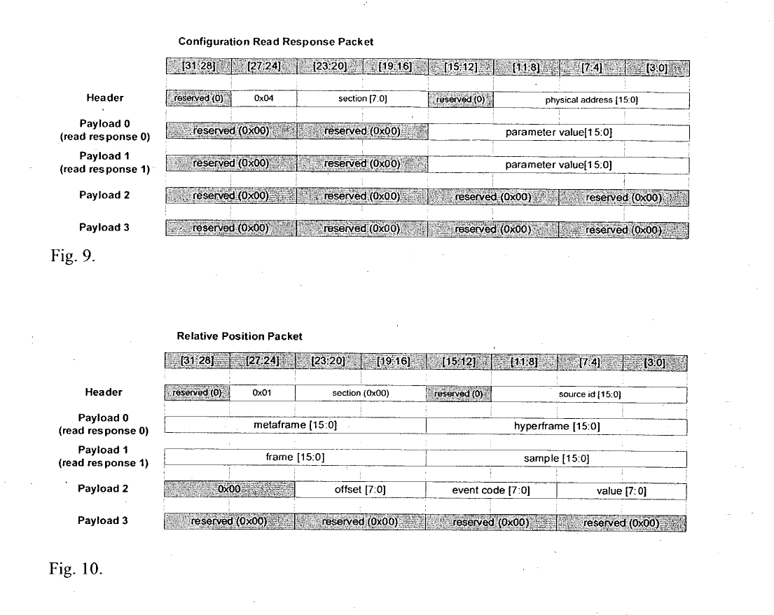

With reference to FIG. 9, a Configuration Read Response packet is sent when an Algorithm responds to the receipt of a Configuration Read packet. This Configuration Read Response packet contains in its header, the information from the (return address) header from the received Configuration Read packet, and contains in its payload, the value(s) of the sought parameter(s).

Configuration-type packets are sent by a higher level (decision-making or supervisory) intelligence. For example, that intelligence monitors a certain Algorithm or Processing Section (e.g. the sub-stream entering it or the sub-stream leaving it) and upon a certain condition being detected, it dynamically changes a parameter of the appropriate Algorithms (by sending Configuration Write packet(s)). Monitored conditions are typically reflective of “real world” external conditions that intelligently compel, for example, an adjustment in amplification gain or in sampling frequency, that in turn will be intelligently reflected in reconfiguring (dynamically where possible) the Algorithms (and more generally, changing the first logic among the Algorithms by changing the parameters of Algorithms).

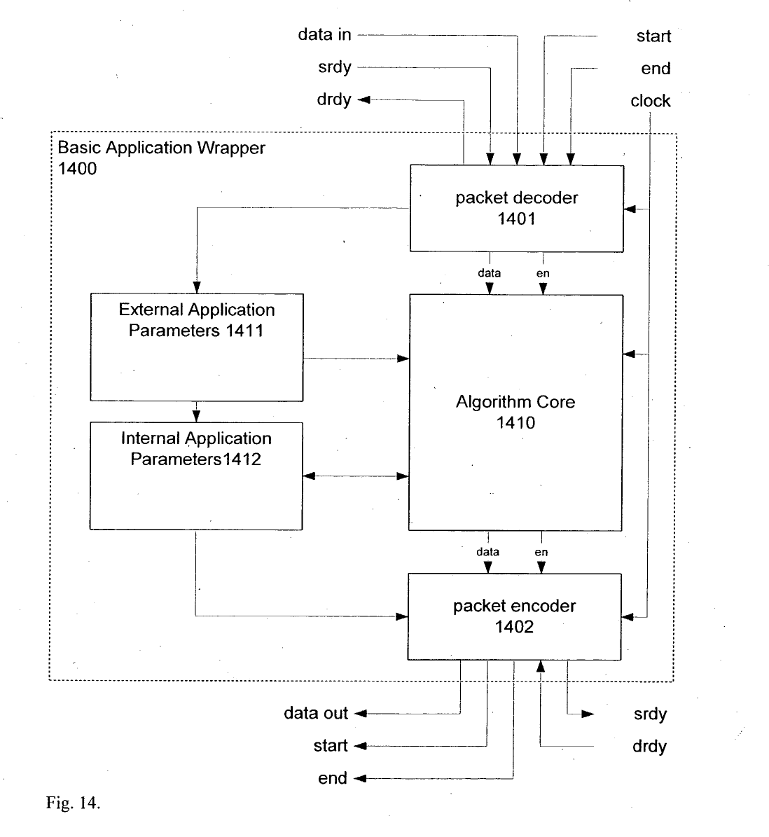

The intelligence resides at the Algorithm level (whether it is in monitored Algorithm or is in another Algorithm or in another Processing Section) or resides at a higher level. When that intelligence resides at a higher level, it is typically (but not necessarily) a direct manifestation of the user application (i.e. operating externally) that is creating and sending Configuration-type packets. In such case (although not shown for simplicity of illustration), one or more Input Portions are dedicated to accept such externally generated Configuration-type packets (in which case, the protocol conversion and some other functions of FIGS. 1-3 are unnecessary) or the Input Portions (of FIGS. 1-3) are adapted to simply “pass along” such externally created Configuration-type packets. The use of Configuration-type packets generally (and the use of Configuration Write packets in particular, to reconfigure dynamically the Algorithms) will be explained more below in conjunction with FIG. 14, Algorithm Wrappers, and Control Steps.

Relative Position Packet

As explained above, a logical relationship is established among packets (by the Input Portion that created them). One conventional relationship may be chronological (e.g. each packet is timestamped by a clock or similar reference outside the packet stream itself, whether by the clock governing the Input Portion or an external clock).

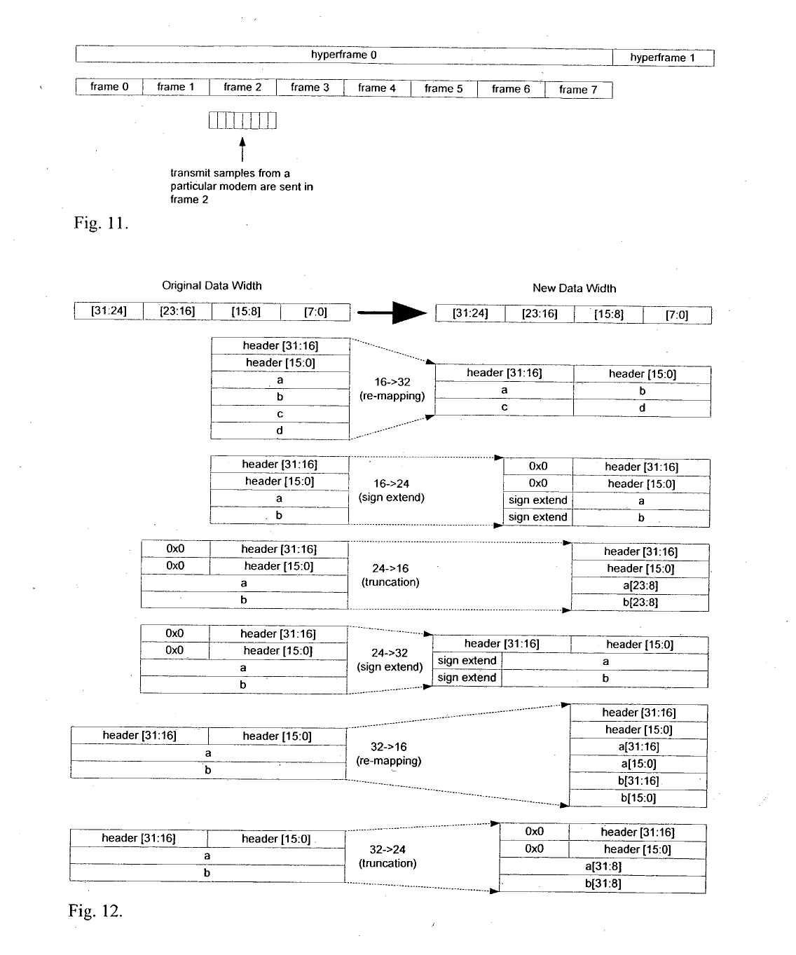

Another relationship may have the form shown in FIG. 11. One analogy to conventional timestamped packets, is packets that are related to each other by their relative locations in a data stream, and accordingly, in a TDMA context, data is identified (e.g. in 16-bit fields and expressed as dotted quads) as <a.b.c.d> where, “d” is the sample # in the frame, “c” is the frame # in the hyperframe. “b” is the hyperframe # in the metaframe and “a” is the metaframe #. Thus a Relative Position packet takes the form, in a TDMA context, of <metaframe#.hyperframe#.frame#.sample#>.

Thus, as an example, the sample of the interest (according to the user application) might be the third sample after a specified frame edge in a specified sub-stream, and the user application calls for the further processing of that sub-stream, to “wait” for the third sample after a certain frame edge in another sub-stream to arrive, and then processes those two and subsequent samples, simultaneously. In other words, an Algorithm intelligently, upon the receipt of the Relative Position packet of <a.b.c.3> of a sub-stream from Processing Section #8, “waits” (i.e. suspends processing of that data stream) until the Relative Position packet of <a.b.c.3> of another sub-stream arrives from Processing Section #9. The practical effect of this is to synchronize these two sub-streams “in real time”.

With reference to FIG. 10, the size of a frame, hyperframe, and metaframe are parameterized values (i.e. subject to reconfiguration by Configure-type packets), and are motivated by the user application, infrastructure overhead and other conventional factors. These values will generally be set to correspond to framing sizes needed by an Algorithm or the associated Processing Section or the user application. For example, in a TDMA context, the hyperframes might be aligned to sets of time slices such that a frame represents a particular transmit slice (see FIG. 11).

The Input Portion (of FIGS. 1-3, for example) is responsible for inserting intelligently a Relative Position packet(s) into the sub-stream at the appropriate places. These packets may then be used to align “receive data” through the remainder of the system. In the case of “transmit data”, Relative Position packets are inserted into the sub-stream by their source (e.g. by the Input Portion reflective of the external part or by the Processing Section or Algorithm that produced it). When the Relative Position packet reaches its final destination, it is used intelligently to align and synchronize the transmit data with other processes and packets (e.g. Data Stream Synchronizer 2000 and FIG. 20).

As an observation about the use of the Relative Position packet format of FIG. 11, note that information about a particular sample of interest, cannot be placed at precisely the same location as the sample itself. Accordingly, a Relative Position packet is always placed in the sub-stream ahead of the data containing the sample that the Relative Position packet information applies to. The distance between the Relative Position packet and the sample it applies to, is expressed in the number of samples therebetween, and is contained in the “offset” field of the Relative Position packet (see FIG. 11).

Other fields of the Relative Position packet may be used for user application-specific issues. For example, the “event code” field (see FIG. 11), can be used to signal synchronization events, such as those used by a standard for time internationally, IRIG-b.

Although the above example concerned samples in a TDMA context, presumably on a roughly chronologically order at least in a localized sense, this invention imposes no limitation on the logical relationship among packets. The generality of the concept of “Relative Position” accommodates any logical relationship among packets that recognizes that even for desired “real time results”, what is critical is the relative position of a specified piece of data relative to other pieces of local or proximate data, and not necessarily the position of the specified piece of data relative to externalities such as a remote, external “real time” clock.

Buses

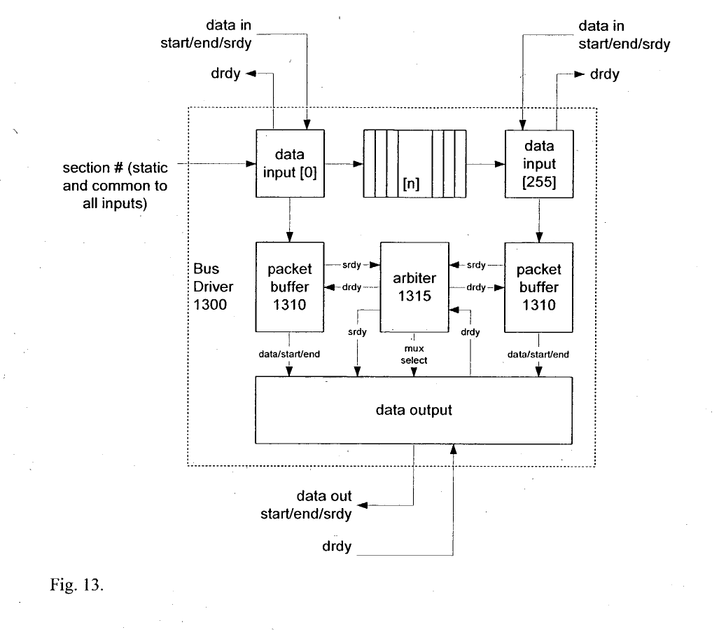

Because the Section # is the first level address of an Output Section or Processing Section, it also identifies the constituent components of the section. For example, in FIG. 3, bus driver 1300 of Output Section #3 is identified by its Section #3. Each bus driver has a Section # synthesized into it, and will accept packets only for that Section # (or when a packet is part of a broadcast (i.e. to all Sections)). Thus a Section # automatically selects the bus a packet is driven to. Bus drivers will be explained below in conjunction with FIG. 13.

The buses are generic (and in particular, they are used by all Input Portions, Processing Sections and Output Sections without customization or modification). They are also agnostic (as to whether a packet is for control, data or some other function). Thus the buses according to this invention, are common communication paths within I/O Wrapper 100.

The total bandwidth into and out of a single Processing Section is limited to a single bus, so Algorithms will typically be designed and assigned to Processing Sections based upon their use of the same data, being motivated by the particular user application. For example, in a digital radio receiver, a Processing Section is likely to consist of Algorithms (for digital down-converting) for external data streams from the same external antenna.

This invention recognizes that a bus that is agnostic (in the sense that it makes no distinction, and needs to make no distinction, between the various types of packets, whether for control or data, and is therefore shared by all types of packets) and a packet addressing scheme that chooses buses with the same address scheme as it chooses any other component at least at the first level (herein, Section #), create many types of efficiencies, one of which is to enhance the ability to scale.

Control Steps

A “Control Step” herein, is a step being one of a series of steps, actions, processes, or measures taken to achieve the goal of control of the processing of sub-streams (and thereby the processing of the external stream(s)). Two categories of Control Steps (information and parameter change) are exemplified, in the preferred embodiment, respectively by the Relative Position packet and the Configuration-type packets. The Relative Position packet provides local information (it operates as a “marker” in the sub-stream). The Configuration-type packets provide re-parameterization of Algorithms and associated administrative functionality. In particular, a Configuration Write packet establishes and modifies data paths (dynamically), or configures (and reconfigures) Algorithm parameters (dynamically).

Control Steps are used in controlling a single sub-stream or two sub-streams. An example of controlling two sub-streams is synchronizing them. Examples of controlling one sub-stream include re-routing it (to another Algorithm, to increase “gain” or obtain “more sampling” or to avoid overflowing buffers, for examples), reconfiguring the Algorithm for that sub-stream (to change the tuning frequency, for example) and gating that sub-stream (to decimate it or make it wait, for example). Some of these examples are explained more fully below.

### Example of Control of Two Sub-streams

In a real-time system, sets of events must be synchronously distributed to processing elements associated with different channels. Conventionally, this requires control buses for distribution. These buses must be capable of supporting as many events as might be signalled simultaneously.

The present invention uses the fact that “real-time events” are actually relative to a position in the data stream, and not to an absolute time (such as a timing reference outside the user application) or even to a “system time” or “sub-system time” (“within” the user application or a clock that governs the locale of the FPGA implementation where the Algorithm resides). Therefore, the critical aspect of a “real time” event is not when it occurs in absolute or system time, but where it occurs in the data stream (i.e. its relative position). For example, in the TDMA context, the critical aspect of a “real time event” according to this invention, is where it occurs in the sample stream, e.g. relative to the preceding frame boundary. A Control Step in this example, operates as a “marker”, and is implemented by a Relative Position packet. Thus for example, consider first and second Algorithms processing respectively first and second sub-streams of packetized data. The first Algorithm could be programmed to suspend processing upon receipt of a particular Relative Position packet (in the TMDA format, e.g. <metaframe#.hyperframe#.frame#.3>) and to continue processing upon receipt of a particular signal from the second Algorithm. In other words, processing of the first data stream waits at the third sample in a particular metaframe/hyperframe/frame until another event and is thus synchronized to that other event.

### Example of Control of One Sub-stream

A sub-stream is advantageously re-routed dynamically (e.g. to take advantage of a processing capability elsewhere that is more suitable for that sub-stream at a particular point thereof). For example, a sub-stream, having reached a certain point of being processed by a first Algorithm, needs to be processed differently and that that is more efficiently accomplished by another Algorithm. In this example, the Control Step is considered as part of intelligently change of the routing of the sub-stream that follows, to that other Algorithm (and is implemented by a Configuration Write packet).

Consider the situation where a first Processing Section is “sampling by 2”. It can be programmed to have also management functions (e.g. monitoring, supervisory and control) operating on a second Processing Section (FIG. 3 shows the level of complexity of inter-Processing Section communications that would enable such). For example, the first Processing Section is programmed to detect (by monitoring the second Processing Section and its performance) that, “sampling by 2” is insufficient (or that the (equivalent of) signal gain is insufficient), and to reconfigure dynamically itself (or another Processing Section) to “sample by 4” (or to reroute the data stream to another Processing Section that can better handle it). With appropriate Configuration Write packets, the Algorithm can be dynamically reconfigured to “sample by 4” (or rerouting Data packets by re-parameterizing the Algorithms with change of destination Section #s of outgoing packets, and mask Source Ids of receiving Algorithms).

Explained above were particular examples of Configuration Write and Relative Position packets as Control Steps. The intelligence that creates and inserts Control Steps appropriately in the appropriate sub-streams: (a) resides at a high level, where it is typically (but not necessarily) a direct manifestation of the user application (i.e. operating externally) that is creates and sends Configuration-type packets to I/O Wrapper 100 and Algorithms therewithin; or (b) is distributed in one or several Algorithms at the Algorithm level (whether it is in the Algorithm that is processing the sub-stream of the embedded Control Step, or it is in another Algorithm). This invention recognizes a generalization of the above particular examples, as one of “localization”, explained below.

“Building Blocks”

Explained below are some components used to implement the invention: packet buffers, bus drivers, and (basic and multiple context) algorithm wrappers.

Packet Buffer

The packet buffer is a packet-based FIFO and is used wherever a data stream must cross a clock boundary.

Input interface in Input Portion (of FIGS. 1-3), contains a set of I/O pins, an external protocol interface, and a packet interface (protocol conversion) whose output protocol is identical to that of all other Input Portions. When that input interface operates in a clock domain other than that of the associated Processing Section(s), data must pass through a packet buffer to allow synchronization. Similarly, output interface in Output Section (of FIGS. 1-3), contains a set of I/O pins, an external protocol interface, and a packet interface (protocol conversion) whose output is appropriate for the user application. When that output interface operates in clock domain other than that of the associated Processing Section(s), data must pass through a packet buffer to allow synchronization.

A packet buffer may also be used to change the data width of a packet. The buffer's input or output may be 16, 24, or 32-bits. FIG. 12 shows (from top to bottom) the input to output changes from 16 to 32, 16 to 24, 24 to 16, 24 to 32, 32 to 16 and 32 to 24 bits, respectively. Common techniques employed are re-mapping, sign extension and truncation.

An example of the use of packet buffering is in the bus driver, explained below.

Bus Driver

With reference to FIGS. 3 and 13, bus driver 1300 takes sub-streams from multiple sources and drives a single output that will likely be connected to multiple destinations. Bus driver 1300 may support up to 256 sources, each of which may be accommodated with packet buffering 1310 (e.g. two packets deep). Available packets are driven onto the bus in a round-robin fashion, managed by arbiter 1315, and may be viewed as a multiplexer, allowing multiple data steams to be merged. In general, bus driver 1300 will be connected to far fewer than 256 sources, and unconnected inputs must be removed by logic synthesis tools.

Bus driver 1300 input will accept a packet only when its header's Section # corresponds to that bus driver 1300's Section # (or when the broadcast address of Section # (0×0) is used). The bus driver's Section # is a static parameter (which is defined at synthesize time or by some offset addressing scheme later). Bus driver 1300 also allows data path widths on its input and output to differ (with the use of packet buffers 1310—see explanation above in conjunction with FIG. 12).

In FIG. 3, the (unnumbered) bus drivers shown at the outputs of Input Portions #0 and #1, because of the nature of their inputs, need not have or exhibit the functionality or structure of bus driver 1300 of FIG. 13, and can be simpler.

Algorithm Wrapper

The preceding explanation involving Algorithms, is introductory and simplified for simplicity of explanation only. In implementation, many (but not all) Algorithms are more appropriately described in conjunction with an “Algorithm Wrapper”. An Algorithm is typically (but not always) implemented by a combination of hardware and software within a Processing Section that encapsulate, supports and executes it (see FIG. 3 relative to FIGS. 1-2). This combination is a communications fabric that provides the Algorithm with data, parameters and control functions, while directing the Algorithm's results to appropriate outputs. This fabric will be termed an “Algorithm Wrapper” when the context requires attention to certain implementation aspects, while the term “Algorithm” will continue to be used to denote the conceptual “algorithm” defined earlier. See FIG. 14 for a more detailed view of an Application Wrapper 1400 hosting Algorithm Core 1410, and where Algorithm Core 1410 in implementation can be considered what “Algorithm” is in concept in FIGS. 1-3.

Within a Processing Section, an Algorithm needs to be identified. This and other details will be explained below.

An Algorithm Wrapper has at least two functions. A first function is to transform the packets (that were useful for moving information within I/O Wrapper 100 and between Algorithms) into a format that is more conducive to processing by Algorithm Core 1410. A second function is to “empower” an Algorithm Core to be more flexibly useful by the use of parameters that can be reconfigured dynamically. These two practical functions will be apparent from the explanation below.

A Basic Algorithm Wrapper and a Multiple Context Algorithm Wrapper will be described next.

Basic Algorithm Wrapper

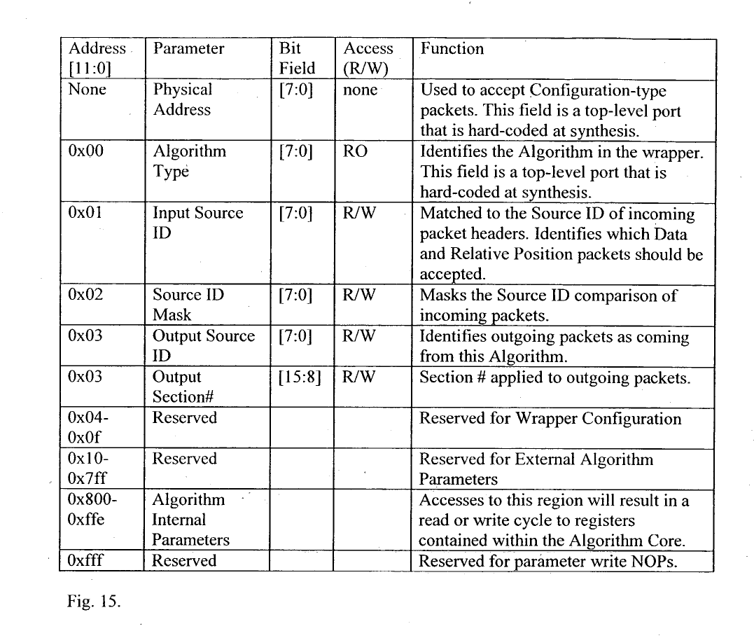

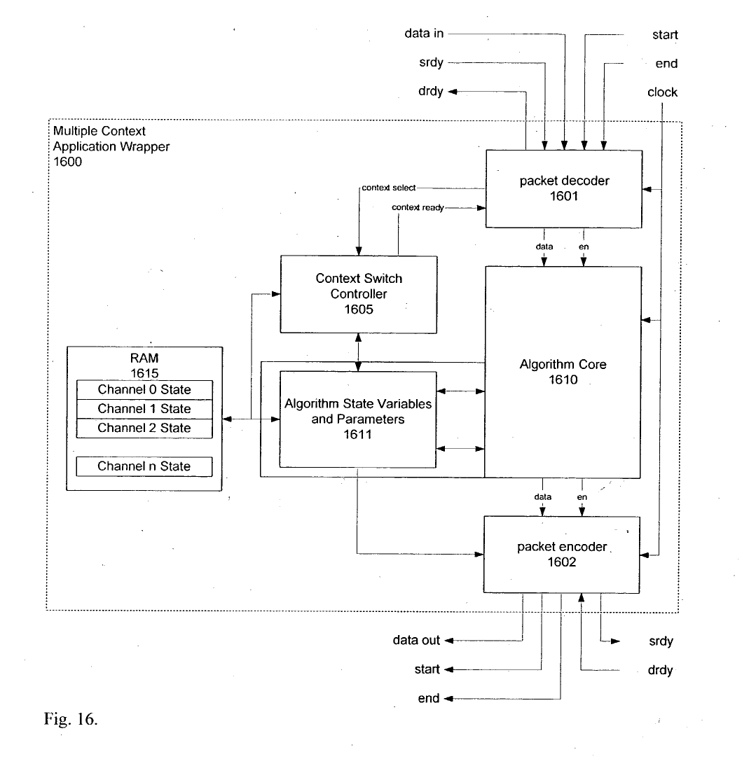

With reference to FIG. 14, Basic Algorithm Wrapper 1400 contains packet decoder 1401, packet encoder 1402 and other necessary and useful (external and internal) parameters 1411 and 1412. FIG. 15 lists those and other exemplary parameters.

Basic Algorithm Wrapper 1400 decodes incoming Data packets into data signals, and decodes Configuration-type packets into parameter-related signals, and ignores packets not addressed to it. The decoded data signals are expressed in a format suitable for forwarding to Algorithm Core 1410. That format is unlikely to be in the aforementioned packet format and more likely in a format that is more “native” or tuned to efficient processing by the implementation of Algorithm Core 1410 (as implemented by the designer). The output of Algorithm Core 1410 is formatted into aforementioned packet format by packet encoder 1402 and placed in the output stream. Basic Algorithm Wrapper 1400 (packet encoder 1402) will apply a new header to its outgoing packets. This header will be given its (destination) Section # and (as set by an earlier Configuration Write packet that wrote it in the “Output Source Id #” parameter field of FIG. 15).

Some parameters are characterized as “static” in the sense that they do not normally change during “processing run time” and change only when a Configuration Write packet addressed to the Algorithm arrives and is processed (see External Algorithm parameters 1411 in FIG. 14 and parameters reserved therefor in FIG. 15). Other Algorithm parameters are characterized as “dynamic” because they change during “processing run time” (see Internal Algorithm parameters 1412 in FIG. 14 and corresponding parameters in FIG. 15).

By use of Configuration Write packets, the External Algorithm parameters can be changed, and thereby “data processing contexts” can be reconfigured dynamically. For example, if the Algorithm is a “multiply by P and add Q” (i.e. parameterized by P and Q), then Basic Algorithm Wrapper 1400's “data processing context” for a data stream might be “multiply by P1 and add Q1”. And then with an appropriate Configuration Write packet sent to Basic Algorithm Wrapper 1400 (to change the values of the relevant static parameters), the processing context thereof becomes (for the stream that follows) “multiply by P2 and add Q2”. For another example, with the appropriate Configuration Write packet, the “Output Section #” parameter field may be changed dynamically so that subsequent outgoing Data packets are destined for a different Processing Section or Output Section than earlier packets were destined for. This might be, for example, to intelligently recognize that certain types of incoming data stream are more efficiently processed by another Processing Section's Algorithms.

Basic Algorithm Wrapper 1400 can handle a single channel (i.e. from a single source) or multiple channels (i.e. from multiple sources). Basic Algorithm Wrapper 1400 accepts multiple channels (i.e. data arriving with/from multiple Source Ids) by using a Source Id mask (see FIG. 15). The bits set in the mask are the only ones that must match the incoming Input Source Id of a packet for it to be accepted. A packet that is produced by the accepting Basic Algorithm Wrapper 1400 and is to be sent to its next Section #, is given by Basic Algorithm Wrapper 1400, a Source Id with values of the incoming Source Id on the bits selected in the mask, and of the Output Source Id register on the remainder.

Packet decoder 1401 may be equipped to handle Algorithms where the quantity of output data is greater than the quantity of input data, by buffering. For example, when a (digital upconverter) DUC is producing sixteen (Intermediate Frequency) IF packets for every baseband packet it receives, the baseband packet will be consumed at the rate of one word for each packet produced. Buffering the baseband packet frees the input bus for other processes.

Multiple Context Algorithm Wrapper

Whereas a “data processing context” is reconfigurable in Basic Algorithm Wrapper 1400 as explained above, it is advantageous in many situations to have multiple processing contexts being processed by an Algorithm Wrapper on a (time or other resource) shared basis. The more general case of Basic Algorithm Wrapper 1400, is Multiple Context Algorithm Wrapper 1600.

Multiple Context Algorithm Wrapper 1600 is similar to Basic Algorithm Wrapper 1400 (with packet decoder 1601, packet encoder 1602, and algorithm state variables and parameters 1611 of FIG. 16 corresponding roughly to their counterparts 1401, 1402, and {1411, 1412} in FIG. 14), with additional functionality expressed as Context Switch Controller 1605, Channel state information 1611 and packet decoder 1601 being adapted to interact with Context Switch Controller 1605.

Provision is made for switching the contexts by changing the static parameters of the Algorithm. Packet decoder 1601 performs these context switches, based upon the Source Id of the next packet to be processed. For an Algorithm to be implemented for a multiple context environment, its internal state must be swappable with others; these states are stored in RAM 1615 and the swapping is managed by Controller 1605.

Multiple Context Algorithm Wrapper 1600 processes multiple channels as Basic Algorithm Wrapper 1400 does, explained above (i.e. with masks).

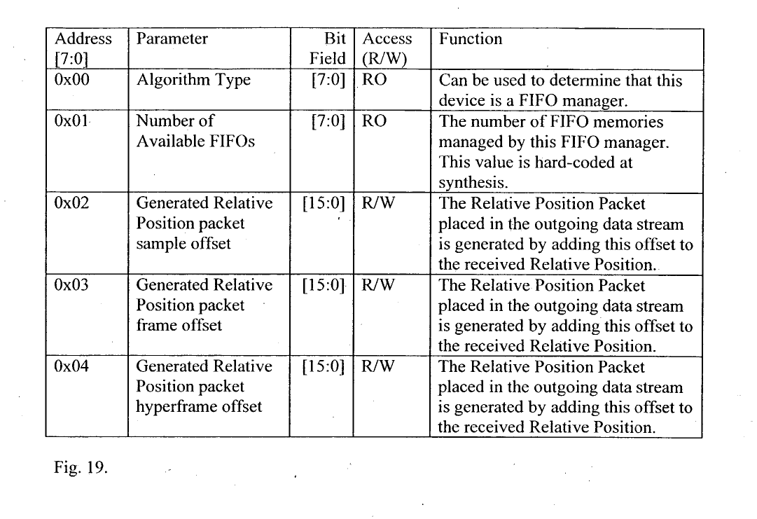

The Algorithm Type parameter is useful in initial configuration of Algorithms. Algorithm Wrappers are synthesized with its Algorithm Type (e.g. Arithmetic Logic Unit or Multiply-by-2) in the corresponding parameter field (see FIG. 15) under a predefined definition scheme. Subsequently, an intelligence would, with that definition scheme and just the {Configuration Read and Configuration Read Response } packet pair relative to the Algorithm Type parameter of an Algorithm Wrapper, know its capabilities. Similarly, a wrapper-less Algorithm (e.g. memory manager 1700) is similarly synthesized with its Algorithm Type in the corresponding parameter field (see FIG. 19). Thus no probing of capabilities is required beyond reading the “self-identification” of the Algorithm Type. Although type-identification of (both wrapped or wrapper-less) Algorithms is typically done during FPGA synthesis as explained above, it is possible to type-identify Algorithms later through, e.g., look-up tables or indirect addressing schemes. Type-identification is useful for the external intelligence as it undergoes the initial recognition, assessment and other configuration steps when first confronted with the synthesized FGPA implementation of this invention.

Two Useful Processeing Sections

Explained below are two specific Processing Sections that are useful to support the “number crunching” and “data processing” of other Processing Sections or external processes, one to operate as an external memory manager (in conjunction with FIGS. 3, 17-19) and the other to synchronize data streams (in conjunction with FIG. 20).

External Memory Manager

A FIFO model allows data streams to be directed to and from external memory the same way that sub-streams are otherwise directed by any other Algorithm. In other words, one, or part of one, of the Processing Sections is used as a memory manager of external memory (see memory manager 1700 in FIG. 3, where external memory is not illustrated for simplicity of illustration therein).

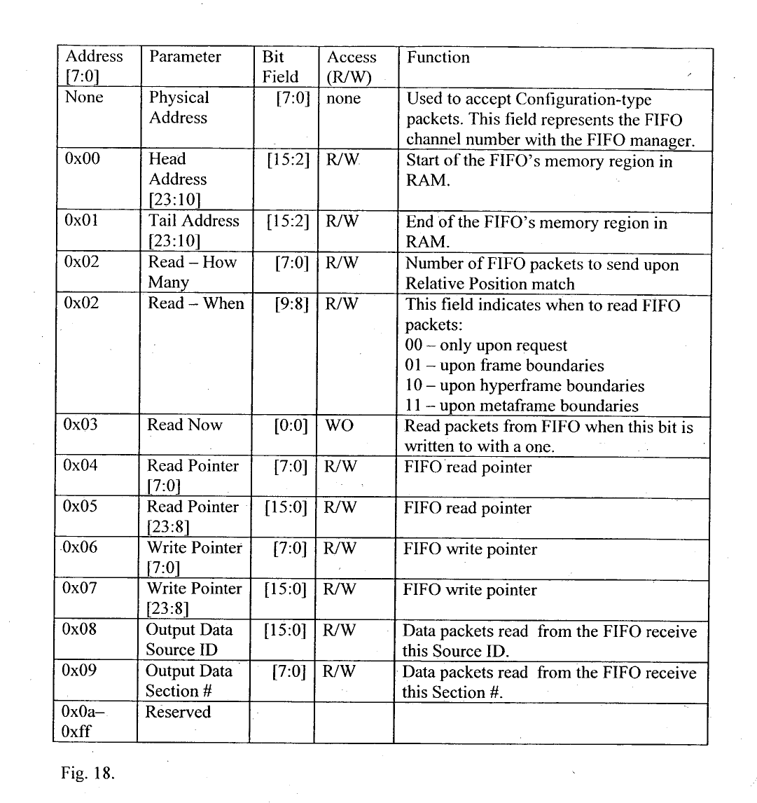

With reference to FIG. 17, external memory interface and manager 1700 interfaces with external memory RAM 1715. Memory manager 1700 operates on a memory-mapped FIFO channel basis. Each FIFO memory channel is parameterized (see explanation below in conjunction with FIG. 18). A special case of a FIFO memory is a circular buffer, which may be viewed as a FIFO that does not overflow (i.e. when the write pointer reaches the read pointer, the read pointer moves to stay ahead of it, and the oldest data is overwritten.)

When a Relative Position packet is received by memory manager 1700, it may cause packets to be read from any or all FIFO memories, as parameterized. Assuming the format of <metaframe#.hyperframe#.frame#.sample#>, each FIFO memory maintains fields that specify whether packets should be read on the boundary of a new frame, hyperframe, or metaframe (see “Read—when” parameter in FIG. 18). In addition, the number of packets to be read may be specified (see “Read—how many” parameter in FIG. 18). A Relative Position packet that is received may also result in the generation of a new Relative Position packet in the output of each FIFO memory. A generated Relative Position packet is calculated by adding a Relative Position offset to the received Relative Position value and is inserted into the outgoing data sub-stream (see “offset” parameters in FIG. 19).

Memory manager 1700 supports 256 FIFO memory channels, and unconnected inputs should be algorithmically automatically removed by logic synthesis tools. The bus driver for memory manager 1700 has its own Section #, so only the Source Id on each channel is needed to select a FIFO memory. As explained earlier, not all Algorithms require an Algorithm Wrapper. Memory manager 1700 is such a wrapper-less Algorithm. The very specificity of the Algorithm that is memory manager 1700, means that it does not need an Algorithm Wrapper 1400 as described above (see FIG. 3), because much of the “administrative interface” work done by an Algorithm Wrapper 1400 is done distributively by or proximate the individual memory channels managed by memory manager 1700 (e.g. Output Source Id and Output Section # parameters in FIG. 18). Memory manager 1700 (physical address 0×00) contains the parameters exemplified in FIG. 19.

The FIFO memory parameters 1710 (as listed in FIG. 18) are mapped to physical addresses 0×01 through 0×ff and are accessible with Configuration-type packets. For Configuration-type packets, memory manager 1700 is selected by its Section # and Physical address 0×00 therein.

The primary difference between a conventional FIFO memory and this invention's managed FIFO memory, is that the latter supports “read pacing” thereof based upon the received Relative Position packet value.

Data Stream Synchronizer

A useful example of a Processing Section using the Relative Position packet, in particular, and of the packetizing taught by this invention, generally, is Data Stream Synchronizer 2000 (see FIG. 20). Data Stream Synchronizer 2000 is useful when a data stream is to be sent to paired D/A converters, in which the samples for two outputs must be aligned “time-wise”.

Data Stream Synchronizer 2000 takes two packet streams (from two respective Input Portions, not shown) and aligns them by using their embedded Relative Position packets, as follows. Whenever a Relative Position packet arrives on either input, it updates the Relative Position of the corresponding stream for that input (its “running timestamp”, to use an approximate analogy). Whenever the Relative Positions of both inputs are unequal, the stream that is “ahead” will be delayed until the Relative Position of the stream that is behind, is updated upon the arrival of its Relative Position packet to be equal (i.e. until both streams are aligned). The delay (or temporary storage) is accomplished with FIFO memories 2040, 2041, under the compare and alignment functions performed by gateway 2050.

Data Stream Synchronizer 2000, as explained, will only operate correctly when its input data streams do not come from multiple data sources. (The module can only handle a single data stream on each input.)

The preceding two examples of Processing Sections, also exemplify different implementations—Data Stream Synchronizer 2000 implemented with a wrapper and Memory Manager 1700 implemented wrapper-less—as a function of the qualities, capabilities and intelligent expectations of the respective Algorithm.

Transportable

As implementing technologies change (for example, if the first FPGA was fuse-based, and was followed by a second, upgraded RAM-based FPGA), and if the change is of a certain quality and nature explained below, this invention provides a method of preserving the value of the “intellectual property” created on the first FPGA, for redeployment in the second FPGA.

With reference to conceptual block diagram of FIG. 1, once the aforementioned rendering of the user application into I/O Wrapper 100 and Processing Section 002 therewithin, is synthesized on a first FPGA with satisfactory results, and if I/O Wrapper 100 (i.e. the combination of Input Portion 001 and Output Section 003) is synthesizable on and is so synthesized on the second FPGA, then this invention provides “transportability” of Processing Section 002 to the second FGPA. Processing Section 002 can be “preserved” as rendered and “moved intact”, or more practically, it is synthesized “as is” (i.e. without modification) onto the second FGPA “within” or in cooperation with synthesized I/O Wrapper 100 thereon. In this way, the “intellectual property value” of the various logics and “glue” of Processing Section 002, and the cradling or hosting function of I/O Wrapper 100, can thus be taken advantage of in varying implementing technologies. The external intelligence for the second FPGA needs to do some initial configuration work (e.g. read Algorithm Type identifications and similar work), and some portions of I/O Wrapper 100 may need to be modified by the designer in response to aspects of the second FPGA that differ from the first FPGA, but these tasks are mostly in the nature of minor “stitching” and “shoehorning” I/O Wrapper 100 onto the second FPGA. In essence, Processing Section 002 (and in particular, the first and second logics governing Algorithms) is simply ready “as is” for useful work in a changed (but still I/O Wrapper 100 cradled) implementation platform.

Localization

In addition to other functions dictated by the user application (such as “number crunching” or “data processing”) and to functions that support such processing (such as external memory manager 1700 and Data Stream Synchronizer 2000), the aforementioned intelligence performs “management of processing” functions. They are typically, administrative, monitoring and supervisory functions, including those related to QOS. Some of these management functions are effected directly and externally by the external intelligence (i.e. the Configuration-type packets that are externally generated and sent to I/O Wrapper 100 and Processing Sections and Algorithms therein). One or several of such management functions can be the task of one Processing Section or Algorithm (1) dedicated to managing (or participating in managing) other (Processing or Output) Sections and/or particular Algorithms within a Processing Section, or (2) dedicated to managing (or participating in managing) an external condition.

An example of (2) might be a particular Algorithm that receives packets indicative of a specified external condition like received Signal Strength in an SDR user application and performs a management function like increasing/decreasing the power of the external gain amplifier by sending the appropriate packets to the Output Section that are translated into the appropriate external control signals directed to the amplifier. Those packets “indicative” of an external condition” may be packets with information originating from an external monitor of that external condition. Alternatively, those packets “indicative” of an external condition” may be those of another Algorithm or Processing Section and by monitoring them (e.g. the sub-stream entering it or the sub-stream leaving that Algorithm or Processing Section), an inference can be intelligently made (e.g. based on mathematical formulas that model external conditions) that is indicative of an external condition. The preceding case of inference, is an example of (1). Another type of example of (1) could one Algorithm or Processing Section, sampling and managing packet buffers in other Algorithms and Processing Sections, in respect of overflows.

Alternatively to the dedicated Algorithm or Processing Section, one or several such management functions can be tasks distributed among several Processing Sections (or Algorithms therewithin) or can be effected by a combination of dedicated and distributed intelligences.

This invention recognizes that control and management functions can be advantageously effected at (or closer to) the most efficient level of processing when using local status information and local control commands. This invention tries to disengage from external (i.e. remote) control (e.g. interrupts, clocks and other external intelligence) to the extent possible in a user application, what is inherently (or at least, most advantageously should be) a locally informed and locally controlled event during processing. The invention provides local status information (e.g. Relative Position packets in the preferred embodiment) and local control (e.g. Configuration Write packets that change routing between Algorithms, or a Data Stream Synchronizer to align two A/D streams, in the preferred embodiment). Obviously, one advantage of localization is that execution can be performed more responsively compared to coordination with a (more remote) external intelligence.

Although the above explanation appears to distinguish between functions for “data processing” and functions for “managing the processing”, any distinction is apparent in most situations only for simplicity of explanation. In fact, as the above explanation and examples show, these two types of functions are connected and interleaved at many levels; and at the local levels where this invention points to and operates advantageously, the dividing line between these two types of functions, is a porous one. The key observation is that as “data processing” is done obviously at a local level, its management should also try to be proximate thereto.

Inserting or embedding a Control Step into the sub-stream (instead of using an external interrupt, for example) is an inventive way to achieve any desired controls of synchronization and rerouting of stream(s) (and otherwise, any re-parameterization of Algorithms). Some management functions are best being locally informed and locally controlled, instead of waiting for (or fetching) external information and control. The relevant information and control aspects of management, are “localized” (to the extent possible within the user application), within the data streams themselves (or very proximate thereto in the processing thereof).

As a particular example of the above inventive concepts of localization, this invention's preferred embodiment, recognizes that synchronization for a time-sensitive user application like TDMA, need not be strictly tied to an external clock (being any clock external to the data stream processing itself or any clock common to the subject data streams). This invention recognizes that “real time synchronization” is advantageously effected by aligning with specified certain key events described by their relative position in the data stream. As such, the term “timestamp” is not completely appropriate when describing the Relative Position packet in the preferred embodiment in the TDMA context. Although the Relative Position packet and its use according to this invention, does “approximate the passage of external time”, it does so with “time” being disconnected from a remote, external clock or reference.

Thus, more generally, a Relative Position packet can be considered as “local information”, i.e. a packet having information about some local status or condition of the sub-stream that it is in, and synchronization of two external streams (or two sub-streams) with the Data Stream Synchronizer example above, is an example of local control.

Designer's Kit

This invention finds applicability at various stages of the design and testing process. In conjunction with a particular implementation technology (for example, a particular FPGA chip), a “designer's kit” can be developed having a plurality of I/O Wrappers 100 or portions thereof, each programmed for specific user application contexts (being different versions of different multiple access methods in SDR, for example). This kit may include specific “building blocks” and Algorithms and Processing Sections (such as those exemplified above, like the external memory manager 1700 and Data Stream Synchronizer 2000). The components of the kit are provided in a form suitable for synthesis on the associated FPGA. The kit is commercialized in that format to designers, so that a designer chooses from the kit the I/O Wrapper and other portions, as appropriate for his particular user application, and then and synthesizes on the associated FPGA. As explained above, the designer reduces or eliminates his need to be concerned with the irregularities of external signals and can concentrate on developing the Algorithms and the (first and second) logical “glue” that binds them.

Furthermore, an FPGA can be synthesized with an I/O Wrapper 100 (and one or more Algorithms and Processing Sections) for a specific user application context (e.g. a particular version of TDMA), and then commercialized in that format to designers.

FPGA Context

FPGAs contain logic blocks that can be configured to compute arbitrary functions, and configurable wiring that can be used to connect the logic blocks, as well as registers, together into arbitrary circuits. Because FPGAs deal with data at a single bit level, FPGAs are “fine grained”. The information that configures the FPGA can be changed quickly, so that a single FPGA can implement “different circuits” at different times. As such, FPGAs would thus appear to be ideal for configurable computing. Further, since the various logic blocks within an FPGA all operate in parallel, FPGAs can often offer dramatically higher processing performance over more traditional processing devices, including DSPs that are typically limited to performing one or two operations per clock cycle. Further, programming an FPGA-based configurable computerized system, is akin to designing an ASIC. The programmer either uses a synthesis tool or designs the circuit manually, both of which require intimate knowledge of the FPGA architecture and substantial design time. As such, programming structures that involve complex decision making are better implemented on a more traditional processor, with FPGAs relegated to well understood algorithmic functions that can be easily parallelized.

Faced with the “parallel, fine-grained, number cruncher”-characteristics of an FPGA, the concept and development of a packetized protocol for programming/using the FPGA (for SDR processing, for example) is counter to where those characteristics would lead the FGPA programmer. Similarly, faced with such characteristics of an FPGA, the concept of localizing information and control proximate to the level of “crunching” with a higher level, packetized protocol, is counter to where such characteristics would lead an FPGA programmer.

Furthermore, and in no way limiting the generality of the foregoing, FPGAs normally do not come with external memory and therefore special interfaces must be created to interact therewith. This invention recognizes that with a unified protocol, no special interfaces are required, and so has provided an exemplary external memory manager 1700 wherein external memory is accessed with the same addressing scheme as a Processing Section or other local part.

Concluding Observations

Above, embodiments (including the preferred embodiment) and variants of this invention, are all illustrative examples and not meant in any limiting way. Hence, the terminological derivatives of “example” used above, such as “exemplary” or exemplifying, are not meant to limit this invention. Without limiting the generality of the preceding explanation of the nature of the examples provided, several specific variations, alternatives and observations are noted below.

Although the preferred embodiment has been described for SDR user applications, this invention is applicable to many other technical fields (audio processing, image processing in the medical and satellite fields, amongst others) where processing objectives and constraints are not dissimilar to those of SDR.

Any references above in the preferred embodiment to specifics of implementation (such as the number of FIFO memory channels, the number of Processing Sections and Output Sections, the lengths of packets, the sizes of frames, etc.), are only nominal values, and are matters of design choices that depend on the user application and conventional implementation constraints.

The format of the Relative Position packet exemplified above as <metaframe#.hyperframe#.frame#.sample#>, is obviously a design choice of the logical relationship that reflects, motivated and is tied to, a user application (TDMA in the preferred embodiment). Other formats are possible and perhaps preferable to be responsively efficient for other user applications.

In the preferred embodiment, the total bandwidth into and out of a Processing Section was limited to a single bus. This invention does not impose such a design. The number of Processing Sections (one or several) and the number of buses dedicated thereto (one or several) is a design choice with conventional tradeoffs to be made.

In the description above of the preferred embodiment, a three level addressing scheme was provided for Configuration-type packets—a first level, Section #; a second level, physical address within a Processing Section or Output Section (i.e. an internal address within the Section); and a yet lower, third level (indirect) address (an offset value) to reach the particular parameter field sought. A two level addressing scheme was provided for Data and Relative Position packets—a first level, Section #; and a second level, Source Id (which although it is indicative of the immediately preceding origin of the packet, it nonetheless functions as part of the destination address because the Algorithm it is presented to, can identify it as being meant, or not, for it as part of the associated logical channel, and can accept or reject the packet accordingly).

The number of levels of the addressing structure, and their nature (e.g. indirect, or Source Id based) is obviously a design choice made responsively to the user application, the designer's rendering into Algorithms and the implementation technologies.

If each Processing Section and Output Section had only one Algorithm therein to be addressed, the Section # is sufficient without the need for a lower level and more internal address. If the Processing Sections and/or Output Sections had a large plurality of internal components to which access needed to be effected and regulated, then another level of addressing can be added (i.e. Section #, sub-Section #, sub-sub-Section #). In the preferred embodiment described above, the description of the lower level address as the “physical address” (typically an offset from the base address of the higher level component) is only the result of the hardware implementation adopted (FPGA). There is no inherent reason why the lower address must be a “physical address” tied to the hardware implementation.

In the description above of the preferred embodiment, the Input Portions (of FIG. 3, for example) have the same packet interface (protocol conversion) so that there is a single packet protocol “spoken” within I/O Wrapper 100. In fact, there is no inherent requirement under this invention that the protocol conversion of one Input Portion must be the same or related to the protocol conversion of another Input Portion. Depending on the user application and the rendering into Algorithms, it is possible that one logical channel (e.g. from Input Portion 001 to Processing Section 002 to Output Section 003 in FIG. 1) operates “independently” of another channel (e.g. another Input Portion to Processing Section to Output Section, not shown in FIG. 1 for simplicity)). One channel is packetized with a protocol motivated by TDMA and the other is packetized with a protocol motivated by CDMA. In such an example, two protocols are “spoken” within I/O Wrapper 100 but the designer still enjoys the aforementioned advantage of using a “simplified grammar” in that for each Processing Section, he knows the relevant protocol and remains “buffered” from the irregularities of the subject external stream. Furthermore, so as to avoid any incorrect or misunderstood limitations of this invention illustrated by the preferred embodiment above, a hybrid CDMA/TDMA user application is possible with this invention (see e.g. U.S. Pat. No. 5,533,013).

In the preferred embodiment and in the preceding variant, (with the exception of externally generated Configuration-type packets), the Input Portions intelligently create packets according to a logic among themselves (although size modification of packets is done downstream by parameterized packet buffers in the Processing and Output Sections). This invention does not require the creative logic to be effected exclusively in the Input Portions. In a variant, within the logical channel created by the Input Portion and Processing Sections, there can be an intermediate portion thereof where the logic among the packets is changed by a Processing Section for routing and processing to other Processing Sections. Thus there could be within a logical channel, different packet protocols operating sequentially after the initial packet protocol established by the Input Portion.

Although the packet protocols explained above, have fixed length packets between two transmission points within I/O Wrapper 100, this invention does not preclude variable length packets. It is a matter of design choice and tradeoff (between conventional factors of speed, determinism, infrastructure overheard, and the like) considered relative to the user application.

The aforementioned multiple protocols variants within I/O Wrapper 100, do not necessarily require a change a complete change in the protocol addressing scheme. For example, the first level Section # addressing scheme can still be used as governing routing within I/O Wrapper 100, thus continuing many of the aforementioned advantages of this invention.

An FPGA is a member of the family of Programmable Logic Devices (PLD). A PLD is a device that has configurable logic and flip-flops (or other memory latches) linked together with programmable interconnect. Memory cells control and define the function that the logic performs and how the various logic functions are interconnected.

A current, common example of a PLD is the FPGA, and although the preferred embodiment has been described with reference to an FPGA implementation, it is understood by those in the art that any PLD (such as Complex Logic Device (CLD) or Programmable Array Logic (PAL)) or any other programmable logic device that shares characteristics of an FPGA are within the scope of this invention. Furthermore, this invention can find advantageous use for implementation with an Application Specific Integrated Chip (ASIC). Although some of the dynamic reconfigurability of an FGPA is not available with an ASIC, the aforementioned advantages of I/O Wrapper 100 for an. FPGA, are still present with an ASIC with minor, design adaptations thereto.

The preferred embodiment terminologically refers to “dynamically reconfigurable FPGAs” or derivative phrasing. The basic concept of dynamic reconfigurability of FPGAs is old but in viewing the present invention relative to the old art, care should be taken to avoid making the wrong conclusions based on similarities in terminology. For example, U.S. Pat. No. 6,185,148 (filed in 1997), teaches the reconfigurability of an entire FPGA (to change the channel symbol rate, the occupied bandwidth, the modulation technique and the multiple access technique, for examples), performed in the order of 100 milliseconds. Current versions of FPGAs are “dynamically reconfigurable” at speeds several orders of magnitude faster but their consequent, “very fine granularity” leads even further away from employing a packet protocol system thereon. Furthermore, there is nothing in U.S. Pat. No. 6,185,148 that teaches anything other than swapping in a completely new set of predefined parameters (e.g. to change the multiple access technique)—it does not teach “reconfiguring dynamically” as that term is meant herein, i.e. changing local parameters “on the fly” (and typically in response to local information) rather than as the result of something that is statically predefined for what is in effect a “re-synthesis” of the entire FPGA. Without a packetized system (like the one taught by this invention), U.S. Pat. No. 6,185,148 cannot be modified to “reconfigure dynamically” in the sense used herein.

Although the methods and systems of the present invention have been described in connection with a preferred embodiment, they are not intended to be limited to the specific forms explained herein, but on the contrary, they are intended to cover such alternatives, modifications, variations and equivalents, as can be reasonably included within the spirit and scope of the invention as defined by the appended claims.

We claim:

1. A method of processing a first external stream according to a user application, comprising the steps of:
(a) rendering the user application into a plurality of algorithms and logically connecting them with paths, all according to a first logic and with common logical communications paths;
(b) instantiating said plurality of algorithms and common logical communications paths;
(c) packetizing the first external stream, where the packets are logically connected among themselves according to a second logic;
(d) dividing said packetized data stream into a plurality of packetized sub-streams according to said first logic, and embedding a Control Step in one said packetized sub-stream;
(e) channelling and processing said plurality of packetized sub-streams, according to said instantiated plurality of logically connected algorithms and common logical communications paths;
wherein two of said packetized sub-streams, asynchronously share one said instantiated common communications path.

2. The method of claim 1, wherein design of said second logic among packets is motivated by the user application for efficiency of computational processing of said packets by said algorithms.

3. The method of claim 2, wherein the first external stream is the result of sequential sampling by the user application of an external signal and wherein said second logic is to identify each packet sequentially according to its sample #.

4. The method of claim 1, where said Control Step is a packet that has local information about a particular packet relative to its packetized sub-stream.

5. The method of claim 4, wherein said local information is embodied in a Relative Position packet that indicates the relative location of said particular packet in its packetized sub-stream.

6. The method of claim 5, wherein the user application seeks the synchronization of the first external stream with a specified event, and uses said Relative Position packet.

7. The method of claim 6, for processing a second external stream according to the steps as performed on the first external stream, and said specified event is part of the second external stream.

8. The method of claim 1, wherein one said algorithm is dynamically reconfigurable by changing a parameter thereof, and said Control Step is a packet that changes said parameter.

9. The method of claim 1, wherein one said algorithm is dynamically reconfigurable by changing a parameter thereof, and said Control Step is a packet that reads a desired parameter.

10. The method of claim 8, wherein said reconfigurable parameter relates to the downstream routing of its output packetized sub-stream.

11. The method of claim 1, wherein one said algorithm includes means for changing the packets having one size, to another size.

12. The method of claim 7, where the rate of arrival of first external stream is different than the rate of arrival of second external stream.

13. The method of claim 12, wherein one said algorithm, with a data stream synchronizer, aligns the first external stream and second external stream.

14. The method of claim 1, in conjunction with external memory, further comprising the step of addressing said external memory in the same way that said algorithms are addressed and wherein one of said algorithms manages external memory accordingly.

15. The method of claim 1, wherein said first logic among said algorithms takes advantage of similarities of processing steps to be performed on the first external stream.

16. A method of processing a first external stream according to a user application, comprising the steps of:
(a) rendering the user application into a plurality of algorithms and logically connecting them according to a first logic and with common logical communications paths;
(b) instantiating said plurality of algorithms and common logical communications paths;
(c) packetizing said external stream, where the packets are logically connected among themselves according to a second logic;
(d) dividing said packetized data stream into a plurality of sub-streams of packets according to said first logic, wherein said first logic includes (i) inserting a packet in one said packetized sub-stream that has local information about a desired portion of that packetized sub-stream, and (ii) using downstream, said local information;
(e) channelling and processing said plurality of packetized sub-streams, according to said plurality of logically connected algorithms;
wherein two of said packetized sub-streams, asynchronously share one said instantiated common communications path.

17. The method of claim 16, wherein control of said channelling and processing is effected locally and said downstream use of local information is part of said local control of said channelling and processing.

18. The method of claim 17, wherein said local information is embodied in a packet that has information about a desired portion of that packetized sub-stream.

19. The method of claim 17, wherein said local control is effected by a packet that changes a parameter in an algorithm.

20. A method of processing a first external stream according to a user application, comprising the steps of:
(a) rendering the user application into a plurality of algorithms and logically connecting them according to a first logic and with common logical communications paths;
(b) instantiating said plurality of algorithms and common logical communications paths;
(c) packetizing said external stream, where the packets are logically connected among themselves according to a second logic;
(d) dividing said packetized data stream into a plurality of sub-streams of packets according to said first logic, wherein said first logic includes (i) inserting packet in one said packetized sub-stream that has local information about a desired portion of that packetized sub-stream, and (ii) using downstream, said local information;
(e) channelling and processing said plurality of packetized sub-streams, according to said plurality of algorithms;
wherein two of said packetized sub-streams, asynchronously share one said instantiated common communications path.

21. The method of claim 20, wherein said downstream use of local information is part of local control of said channelling and processing.

22. The method of claim 21, wherein design of said second logic among packets is motivated by the user application for efficiency of computational processing of said packets by said algorithms.

23. The method of claim 22, wherein the first external stream is the result of sequential sampling by the user application of an external signal and wherein said second logic is to identify each packet sequentially according to its sample #.

24. The method of claim 20, where said local information relates to a particular packet relative to its packetized sub-stream.

25. The method of claim 24, wherein said local information is embodied in a Relative Position packet that indicates the relative location of said particular packet in its packetized sub-stream.

26. The method of claim 25, wherein the user application seeks the synchronization of the first external stream with a specified event, and uses said Relative Position packet.

27. The method of claim 26, for processing a second external stream according to the steps as performed on the first external stream, and said specified event is part of the second external stream.

28. The method of claim 20, wherein one said algorithm is dynamically reconfigurable by changing a parameter thereof, and said local information is a packet that changes said parameter.

29. The method of claim 20, wherein one said algorithm is dynamically reconfigurable by changing a parameter thereof, and said local information is a packet that reads a desired parameter.

30. The method of claim 28, wherein said reconfigurable parameter relates to the downstream routing of its output packetized sub-stream.

31. The method of claim 20, wherein one said algorithm includes means for changing the packets having one size, to another size.

32. The method of claim 27, where the rate of arrival of first external stream is different than the rate of arrival of second external stream.

33. The method of claim 32, wherein one said algorithm, with a data stream synchronizer, aligns the first external stream and second external stream.

34. The method of claim 20, in conjunction with external memory, further comprising the step of addressing said external memory in the same way that said algorithms are addressed and wherein one of said algorithms manages external memory accordingly.

35. The method of claim 20, wherein said first logic among said algorithms takes advantage of similarities of processing steps to be performed on the first external stream.

36. A method of processing an external stream according to a user application, comprising the steps of:
(a) rendering the user application into a plurality of algorithms and logically connecting them according to a first logic and with common logical communications paths;
(b) instantiating said plurality of algorithms and common logical communications paths;
(c) providing an I/O wrapper for receiving parts of external stream that are irregular and packetizing said external stream, where the packets are logically connected among themselves according to a second logic;
(d) dividing said packetized data stream into a plurality of sub-streams of packets according to said first logic, wherein said first logic includes (i) inserting one packet in one said packetized sub-stream that has local information about a desired portion of that packetized sub-stream, and (ii) using downstream, said local information;
(e) channelling and processing said plurality of packetized sub-streams, according to said plurality of algorithms;
wherein two of said packetized sub-streams, asynchronously share one said instantiated common communications path.

37. A kit for programming an user application on a synthesizable hardware platform, comprising:
(a) a library of run-time synthesis tools employable on the hardware platform, for processing packets according to a desired algorithm;
(b) an I/O wrapper that is preprogrammed on a first hardware platform for accepting two input data streams arriving asynchronously in the format of said user application, and for packetizing them for a synthesized algorithm.

38. The kit of claim 37, further including a second hardware platform programmed with said I/O wrapper, whereby said synthesized algorithm is insertable without modification, onto said second hardware platform to be hosted by said I/O wrapper.

39. A method of processing an external stream according to a user application, comprising the steps of:
(a) rendering the user application into a plurality of algorithms and logically connecting them according to a first logic and with common logical communications paths;
(b) instantiating said plurality of algorithms and common logical communications paths;
(c) packetizing said external stream, where the packets are logically connected among themselves according to a second logic;
(d) dividing said packetized data stream into a plurality of sub-streams of packets according to said first logic;
(d) channelling and processing said plurality of packetized sub-streams, according to said plurality of algorithms;
wherein control of said channelling and processing of said plurality of sub-streams, is effected by being locally informed and locally controlled.
using information physically proximate to the packets and control commands at the packet-level.

40. The method of claim 39, wherein design of said second logic among packets is motivated by the user application for efficiency of computational processing of said packets by said algorithms.

41. The method of claim 40, wherein the first external stream is the result of sequential sampling by the user application of an external signal and wherein said second logic is to identify each packet sequentially according to its sample #.

42. The method of claim 39, wherein said step of being locally informed includes using a packet that has local information about a particular packet relative to its packetized sub-stream.

43. The method of claim 42, wherein said local information packet is a Relative Position packet that indicates the relative location of said particular packet in its packetized sub-stream.

44. The method of claim 43, wherein the user application seeks the synchronization of the first external stream with a specified event, and uses said Relative Position packet.

45. The method of claim 44, for processing a second external stream according to the steps as performed on the first external stream, and said specified event is part of the second external stream.

46. The method of claim 39, wherein one said algorithm is dynamically reconfigurable by changing a parameter thereof, and said step of being locally controlled includes use of a packet that changes said parameter.

47. The method of claim 39, wherein one said algorithm is dynamically reconfigurable by changing a parameter thereof, and said step of being locally informed includes a packet that reads a desired parameter.

48. The method of claim 46, wherein said reconfigurable parameter relates to the downstream routing of its output packetized sub-stream.

49. The method of claim 39, wherein one said algorithm includes means for changing the packets having one size, to another size.

50. The method of claim 45, where the rate of arrival of first external stream is different than the rate of arrival of second external stream.

51. The method of claim 45, wherein one said algorithm, with a data stream synchronizer, aligns the first external stream and second external stream.

52. The method of claim 39, in conjunction with external memory, further comprising the step of addressing said external memory in the same way that said algorithms are addressed and wherein one of said algorithms manages external memory accordingly.

53. The method of claim 39, wherein said first logic among said algorithms takes advantage of similarities of processing steps to be performed on the first external stream.

54. A method of processing an external stream according to a user application, comprising the steps of:
(a) rendering the user application into a plurality of algorithms and logically connecting them according to a first logic and with common logical communications paths;
(b) instantiating said plurality of algorithms and common logical communications paths;
(c) packetizing said external stream, where the packets are logically connected among themselves according to a second logic;
(d) dividing said packetized data stream into a plurality of sub-streams of packets according to said first logic;
(e) channelling and processing said plurality of packetized sub-streams, according to said plurality of algorithms;
wherein two of said packetized sub-streams, asynchronously share one said instantiated common communications path, and
where instantiation, channelling and processing are effected with an implementation technology that is more suitable for non-packet architectures.

55. The method of claim 54, wherein said implementation technology uses a Programmable Logic Device.

56. The method of claim 55, wherein said implementation technology uses an FPGA.

57. A system for processing a first external stream according to a user application, comprising:
(a) an instantiated plurality of algorithms rendered from the user application, which are logically connected with paths, all according to a first logic and with common logical communications paths;
(b) packetizer for packetizing the first external stream into first and second sub-stream of packets where the packets are logically connected among themselves according to a second logic;
(c) a Control Step embedded into one said packetized sub-stream;
wherein two of said packetized sub-streams, asynchronously share one said instantiated common communications path.

58. The system of claim 57, wherein design of said second logic among packets is motivated by the user application for efficiency of computational processing of said packets by said algorithms.

59. The system of claim 57, wherein the first external stream is the result of sequential sampling by the user application of an external signal and wherein said second logic is to identify each packet sequentially according to its sample #.

60. The system of claim 57, where said Control Step is a packet that has local information about a particular packet relative to its packetized sub-stream.

61. The system of claim 60, wherein said local information is embodied in a Relative Position packet that indicates the relative location of said particular packet in its packetized sub-stream.

62. The system of claim 57, wherein the user application seeks the synchronization of the first external stream with a specified event, and uses said Relative Position packet.

63. The system of claim 62, further comprising means for receiving a second external stream and means for processing that second external stream according to the steps as performed on the first external stream, and wherein said specified event is part of that second external stream.

64. The system of claim 57, wherein one said algorithm is dynamically reconfigurable by changing a parameter thereof, and said Control Step is a packet that changes said parameter.

65. The system of claim 57, wherein one said algorithm is dynamically reconfigurable by changing a parameter thereof, and said Control Step is a packet that reads a desired parameter.

66. The system of claim 65, wherein said reconfigurable parameter relates to the downstream routing of its output packetized sub-stream.

67. The system of claim 57, wherein one said algorithm includes means for changing the packets having one size, to another size.

68. The system of claim 63, where the rate of arrival of first external stream is different than the rate of arrival of second external stream.

69. The system of claim 68, wherein one said algorithm, with a data stream synchronizer, aligns the first external stream and second external stream.

70. The system of claim 57, in conjunction with external memory, further comprising the step of addressing said external memory in the same way that said algorithms are addressed and wherein one of said algorithms manages external memory accordingly.

71. The system of claim 57, wherein said first logic among said algorithms takes advantage of similarities of processing steps to be performed on the first external stream.

72. The system of claims 1, 16, 20, 36, 37, 39, 54 and 57, wherein the first external stream is generated by a software program running on a computer.
